(19) United States
(12) Patent Application Publication
(10) Pub. No.: US 2026/0070810 A1
(43) Pub. Date: Mar. 12, 2026

(54) TUNGSTEN DOPED MULTI-IONIC CATHODE

(71) Applicant: GEGADYNE ENERGY LABS PRIVATE LIMITED, Thane (West) (IN)

(72) Inventors: Ameya Pradeep GADIWAN, Mumbai (IN); Jubin Varghese KANNAMMOOTTIL, Mumbai (IN)

(21) Appl. No.: 19/108,665

(22) PCT Filed: Sep. 8, 2023
(86) PCT No.: PCT/IN2023/050850

§ 371 Date: Mar. 4, 2025

(30) Foreign Application Priority Data
Sep. 10, 2022 (IN) 202221051752

(51) Int. Cl. C01G 53/51

(52) U.S. Cl. CPC C01G 53/51; C01P 2002/54; C01P 2006/40

(57) ABSTRACT

The present invention discloses to tungsten doped mixed cationic cathodes for energy devices notably non-aqueous re-chargeable alkali-ion electrochemical cells and batteries and to the process of preparation thereof. More particularly, the present invention discloses to doped cathode active materials of Formula (I) that show a higher capacity and which can able to retains their structure during the entire charging-discharging cycles.

### FIELD OF INVENTION

The present invention relates to tungsten doped cathode material that contains active material made up of layered transition metal oxides-based structure, for rechargeable metal-ion batteries. The present invention further discloses a method of producing tungsten doped cathode material having novel anionic stoichiometry capable of preparing alkali-ion batteries.

### BACKGROUND AND PRIOR ART OF THE INVENTION

With the ever-increasing energy consumption and demands on energy sources, renewable energy storage systems with low cost, high efficiency, long lifespan, and adequate safety are essential. Among all the energy storage techniques, rechargeable batteries are one of the most efficient technologies for storing electricity and powering electronic devices. The rechargeable battery is even the core component of electric vehicles (EVs), which requires high performance.

Critical battery characteristics such as specific capacity, cycling stability, and operation voltage largely depend on the intrinsic electrochemical properties of the electrode materials. The electrodes (mainly the cathode) are the limiting factors in terms of overall capacity, i.e. energy density, and cyclability, therefore, the main concern in the rechargeable battery system is to find suitable electrode materials, especially cathode materials, which, to a great extent, determine the energy density of a battery. Examples include metal oxide, polyanions, organic compounds, and others.

The most general formula used for describing transition metal oxides based on alkali metal ion cathode material is A_{X}MO₂, where M represents one or more metal ions having different oxidation states. The A_{X}MO₂ usually adopts an O3-type stacking sequence. The O3 phase is composed of alternate alkali metal ion layers and transition-metal (M) layers in the oxygen-ion framework, packed closely in the ABCABC pattern, in which alkali ions and M ions are respectively located in the octahedral sites. P2-phase is stacked in the ABBAABBA manner, with all the alkali ions occupying the trigonal prismatic sites of the alkali layers.

The exact position of the alkali metal ion defines what will be the structure of metal oxide i.e. octahedral, tetrahedral, or prismatic. These layered materials consist of MO₆ edge-sharing octahedral units forming (MO₂) n sheets, in between which the sodium cation is coordinated octahedral (O), tetrahedral (T), or prismatic (P). O-type layered oxides comprise sodium ions in octahedral sites, while P-type materials accommodate the alkali ions in prismatic sites. The most common structures for layered transition metal oxides are O3, P2, and P3-type, whereby the number indicates the number of transition metal layers in the repeating cell unit. Transition metal layered oxides have attractive properties as cathode materials for rechargeable batteries, such as the ease of synthesis and the high feasibility and reversibility of the sodium shuttling process, thus, allowing a good overall electrochemical performance.

The most promising class of transition metal oxide material is the layered metal oxides. Layered transition metal oxides have gained considerable attention due to their simple structure, ease of synthesis, high operating potential, and feasibility for commercial production. The biggest challenges faced by this material include high capacity, cycle stability, high rate capacity, being environmentally friendly, and so on. Layered transition metal oxide cathodes have a higher theoretical capacity, faster sodium ion diffusion, and smaller electrode polarization. In addition, the structure of the layered metal oxide cathode is tailorable. By means of appropriate component modulation and process conditions, it is possible to prepare layered transition metal oxides with target structures. For example, little difference in transition metal element or Na content can result in a transition between P2- and O3-type structures. The synthesis methods of layered materials are generally the traditional solid-phase reaction methods, co-precipitation, and sol-gel methods, which are relatively mature and simple, and therefore the preparation of layered transition metal oxide materials has certain industrial feasibility.

Metal doping is proven to be an important and reliable approach to stabilize the interslab spaces, reduce multiple phase transitions, and lead to enhancements in the long-term cycling and output voltage in the preparation of layered transition metal oxides. Research has been extended from A_{X}MO₂ with a single transition metal to compounds with two, three, and even four or more metal ions by introducing different metals into the A_{X}MO₂ framework, taking advantage of the unique characteristics and synergetic contributions of various metal elements.

Although various doping elements (Al, Mg, Ti, Fe, Ca, Zr, Y, Ta, and Si) have been attempted to improve the cycling characteristics of the Ni-rich layered cathodes, improvement in cycling stability has been marginal. In particular, most layered cathodes were unable to deliver a capacity exceeding 210 mA h g 1 and, moreover, an improvement in cycling stability was usually sacrificed by a reduced discharge capacity.

US Patent Publication No. 20210344012 discloses a tungsten-doped lithium manganese iron phosphate-based particulate for a cathode, and including a composition represented approximately by a formula LiₓMn_{0.998-y-z}Fe_{y}M_{z}W_{0.002}PₐO_{4a±p}/C, M is a metal combination that includes Mg and Ti: 0.9≤x≤1.2:0.1≤y≤0.4; 0≤z≤0.08:0.098<y+z<0.498; 0.85≤a≤1.15; 0<p<0.1; and C is in an amount of larger than 0 wt % and up to 3.0 wt % based on total weight of the composition.

US Patent Publication No. 20220013774 discloses a cathode active material for a lithium secondary battery having a core containing lithium composite metal oxide is a substance represented by the following Formula Li [LiₓM_{1-x-y}D_{y}]O₂₋ₐQₐ; wherein, M includes at least one transition metal element that is stable in a 4- or 6-coordination structure; D includes at least one element selected from alkaline earth metal, transition metal, and non-metal as a dopant: Q includes at least one anion; and 0≤x≤0.1, 0≤y≤0.1, 0≤a≤0.2.

PCT Patent Publication No WO2001020695 discloses an electrode composition including a polymeric binder material and a doped tungsten (IV) oxide active material suitable for use in an electrochemical cell. The active material includes a tungsten (IV) oxide host material and a metal dopant in the host material effective to increase the charge-discharge capacity per unit weight of the active material when used in an electrochemical cell.

Hoon-Hee Ryu et al., in a research study published in Journal of Materials Chemistry A, 2019 titled “Suppressing Detrimental Phase Transitions via Tungsten Doping of LiNiO2 Cathode for Next-Generation Lithium-Ion Batteries” disclosed a Tungsten doped LiNiO2 material for high-energy-density cathodes. The article teaches that Tungsten doping reduces the structural stress associated with the repetitive phase transition by reducing the abrupt lattice collapse/expansion, thereby improving the cathode's cycling stability.

Yong-Qi Sun et al., in a review paper published in Tungsten, 2021 titled “The role of tungsten-related elements for improving the electrochemical performances of cathode materials in lithium-ion batteries” disclosed the role of tungsten-related elements in improving the electrochemical performances of cathode materials in lithium-ion batteries. The article further shows that the use of tungsten and related elements for doping/coating is a promising strategy to improve the cycle stability of the layer-structure cathode materials, particularly for the lithium-ion batteries.

Geon-Tae Park et al., in a research study published in the Journal of Power Sources, 2019 titled “Tungsten doping for stabilization of Li [Ni_{0.90}Co_{0.05}Mn_{0.05}]O₂ cathode for Li-ion battery at high voltage” disclosed the improvement in the performance of tungsten doped cathodes through various experimental observations. The article further teaches that tungsten doped cathodes provide better cycling stability, and superior chemical stability, further suppressing detrimental phase transition and micro cracks.

On analyzing the literature pertaining to rechargeable batteries, there appears need in the art to provide an improved cathode active material for energy storage devices or alkali-ion electrochemical cell which is capable of delivering high specific capacity with little or no fading on cycling, and yet being cost-effective.

### OBJECT OF INVENTION

Accordingly, the main objective of the present invention is to provide a tungsten doped cathode material made up of layered transition metal oxides for rechargeable alkali ion batteries.

Another object of the present invention is to provide an electrochemical cell exhibiting a higher capacity prepared by using a cathode containing the tungsten doped active material.

### SUMMARY OF THE INVENTION

Accordingly, the present invention discloses a positive electrode material exhibiting a novel anionic stoichiometry, suitable for preparing energy storage devices. Accordingly, the present invention provides a mixed cation doped cathode active material of layered transition metal oxides-based structure suitable for rechargeable metal-ion batteries with higher capacity.

In an aspect of the present invention, the tungsten doped mixed cation cathode active material is represented by formula (I) comprising;

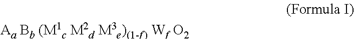

Wherein,
‘A’ comprises one or more alkali metal selected from Sodium, Lithium, Potassium and the like;
‘B’ comprises one or more alkali metal selected from Sodium, Lithium, Potassium and the like;
M¹ is the transition metal in the oxidation state +2;
M² is the transition metal in the oxidation state +3;
M³ is the transition metal in the oxidation state +4;
W is tungsten in oxidation state +3;
Wherein
0.67≤a≤1, preferably 0.85≤a≤1, further preferably 0.95≤a≤1;
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333;

In particular, preferred cathode material have c+d+e+f=1.

In a preferred aspect of the present invention, the tungsten doped cathode active material is represented by formula (IA) comprising;

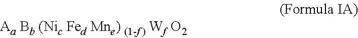

Wherein,
‘A’ comprises one or more alkali metals selected from Sodium, Lithium, or Potassium;
‘B’ comprises one or more alkali metals selected from Sodium, Lithium, or Potassium;
Ni is nickel in oxidation state +2;
Fe is iron in oxidation state +3;
Mn is manganese in oxidation state +4;
W is tungsten in oxidation state +3;
Wherein,
0.67≤a≤1, preferably 0.85≤a≤1, further preferably 0.95≤a≤1;
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333,
Wherein the cathode material have c+d+e+f=1.

In another aspect of the present invention, the mixed cation doped cathode active material of Formula (I) comprises:
i. Na_{0.95}K_{0.05}Ni_{0.33} Fe_{0.33} Mn_{0.33} W_{0.01}O₂,
ii. Na_{0.95}K_{0.05}Ni_{0.327}Fe_{0.327}Mn_{0.327} W_{0.02}O₂, and
iii. Na_{0.95}K_{0.05}Ni_{0.316}Fe_{0.316}Mn_{0.316} W_{0.05} O₂

In an aspect of the present invention, the process for the preparation of the cathode material of Formula (I) comprising co-precipitating a ternary/binary hydroxide of the base transition metal elements and further mixing with stoichiometric ratios of respective A, B, and W and calcination of the mixture to facilitate the compound formation. Such a process may be conveniently performed in the presence of air, but it may also be performed under an inert atmosphere.

In preferred aspect of the present invention, the process for the preparation of the cathode active material of Formula (I) comprises the steps:
i. Preparing separate solutions of the base metal C, D & E in their respective stoichiometric ratios, and the second solution of a mixture of 1% or 2% or 5% Tungstic acid dissolved in both NaOH and NH4OH solutions, wherein the second solution is further kept for vigorous stirring under an N2 atmosphere;
ii. Mixing the above two solutions simultaneously drop wise into a fixed volume stirred reactor followed by aging (maturing) for a period of 12 hrs, under the stirring condition to allow homogenous particle formation, which is then washed, neutralized, and dried to form the ternary hydroxides;
iii. Intimately mixing the obtained ternary hydroxides of step (ii) with stoichiometric quantities of A and B salts;
iv. Heating the resulting mixture in a furnace under a suitable atmosphere and within a single temperature or over a range of temperatures between 450° C. and 900° C. until reaction product forms; and
v. Allowing the product to cool before grinding it to a powder.

In another preferred aspect of the present invention, the base metals C, D & E are Ni, Fe & Mn respectively.

In an aspect of the present invention, the doped cathode active material of Formula (I) find application in alkali ion-cell, in energy storage devices such as batteries, rechargeable batteries, electrochemical devices, and electrochromic devices.

In another aspect of the present invention, the alkali-ion electrochemical cell comprising;
(i) the cathode consisting of tungsten doped mixed cation active material of the formula (I);

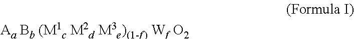

Wherein,
‘A’ comprises one or more alkali metal selected from Sodium, Lithium, Potassium and the like;
‘B’ comprises one or more alkali metal selected from Sodium, Lithium, Potassium and the like;
M¹ is the transition metal in the oxidation state +2;
M² is the transition metal in the oxidation state +3;
M³ is the transition metal in the oxidation state +4;
W is tungsten in oxidation state +3;
Wherein
0.67≤a≤1, preferably 0.85≤a≤1, further preferably 0.95≤a≤1,
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333;
(ii) an anode selected from graphite, hard carbon, and silicon;
(iii) a separator; and
(iv) a non-aqueous electrolyte comprising 0.8M NaPF6-PC:EMC:FEC:PST:DDT composition.

In a preferred aspect, the cathode material in the electrochemical cell consists of c+d+e+f=1

### DETAILED DESCRIPTION OF THE DRAWINGS

The invention has other advantages and features which will be more readily apparent from the following detailed description of the invention and the appended claims, when taken in conjunction with the accompanying drawings, in which:

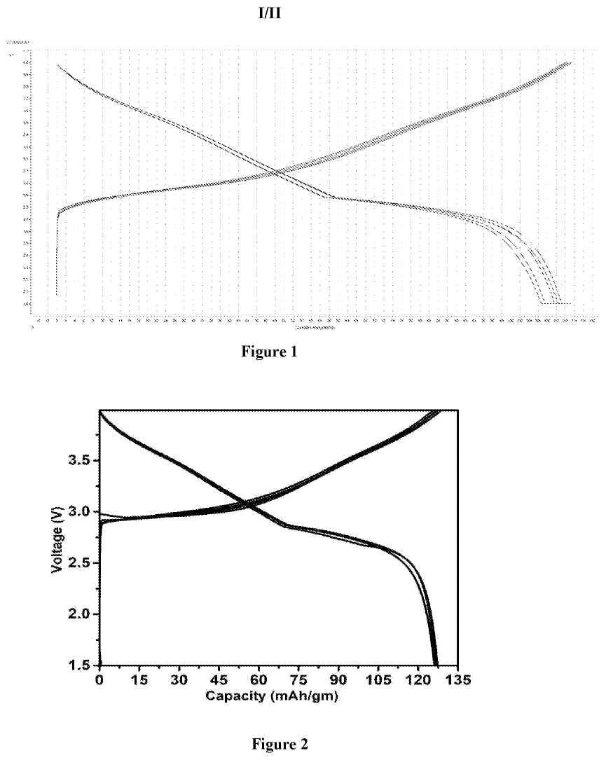

FIG. 1: depict a schematic representation of cell voltage profile for the first 5 charge/discharge cycles of the a half-cell having sodium metal as anode material and Na Ni_{0.333} Fe_{0.333} Mn_{0.333} O₂ as cathode active material which is charged up to 4V at 25 degrees using 0.8M NaPF6-PC:EMC:2% FEC:1% PST:1% DTD as electrolyte.

FIG. 2: depict a schematic representation of cell voltage profile for the first 5 charge/discharge cycles of the a half-cell having sodium metal as anode material and Na Ni_{0.33} Fe_{0.33} Mn_{0.33} W_{0.01}O₂ as cathode active material which is charged up to 4V at 25 degrees using 0.8M NaPF6-PC:EMC:2% FEC:1% PST:1% DTD as electrolyte.

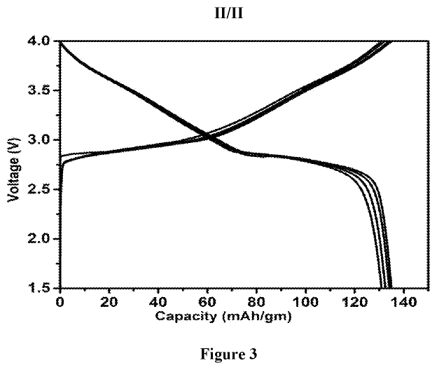

FIG. 3: depict a schematic representation of cell voltage profile for the first 5 charge/discharge cycles of a half-cell having sodium metal as anode material and Na_{0.95}K_{0.05} Ni_{0.33} Fe_{0.33}Mn_{0.33} W_{0.01}O₂ as cathode active material which is charged up to 4V at 25 degrees using 0.8M NaPF6-PC:EMC:2% FEC:1% PST:1% DTD as electrolyte.

### DETAILED DESCRIPTION OF THE INVENTION

### Abbreviations

EMC: Ethyl Methyl Carbonate
PC: Propylene Carbonate
FEC: Fluoroethylene Carbonate
PP: Polypropylene
DTD: Ethylene Sulfate (1,3,2-Dioxathiolane 2,2-dioxide)
PST: prop-1-ene-1,3-sultone

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The tables, figures and protocols have been represented where appropriate by conventional representations in the drawings, showing only those specific details that are pertinent to understanding the embodiments of the present invention so as not to obscure the disclosure with details that will be readily apparent to those of ordinary skill in the art having benefit of the description herein.

As used herein, the term “element”, when used in the context of the present invention, refers to a member of the periodic table and has the suitable oxidation state when the element is used in combination with other members of the periodic table.

Accordingly, to accomplish the objectives of the present invention, the inventors propose a positive electrode material, suitable for preparing energy storage devices. Accordingly, the present invention provides a mixed cathode active material made up of layered transition metal oxides-based structure suitable for preparing rechargeable metal-ion batteries with higher capacity.

In an embodiment of the present invention, the mixed cathode material with optimized stoichiometry such that the O3 structure of the formed cathode is doped with larger alkali ions as well as tungsten ions (W) and results in enlarged interlayer spacing, providing larger channels for ion movement.

In another embodiment of the present invention, doping with tungsten (W) will greatly increase the structural stability of the mixed cathode material because of the formation energy. The greater the formation energy of metal oxide more stable the material will be. The formation energy of the intercalation of Alkali metal ion (Ef) is shown in Equation

$${E}_{f} = {E}_{{t}^{-}} {E}_{dil} - {E}_{dilafter}$$

Where, Et is the total energy of the supercell, Edil is the deintercalation energy of alkali metal ion, and Edilafter is the energy after the deintercalation of alkali metal ion. The formation energy of W—O is in the range 598 to 632 KJ/mol, compared to the Metal-O (Ni/Co/Mn) which is 391.6 kJ/mol, 397.4±8.7 KJ/mol, and 402 kJ/mol and thus helps in increasing the structural stability.

In still another embodiment of the present invention, the tungsten doped mixed cation cathode active material is represented by formula (I), comprising;

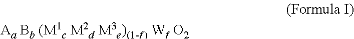

Wherein,
‘A’ comprises one or more alkali metal selected from Sodium, Lithium, Potassium and the like;
‘B’ comprises one or more alkali metal selected from Sodium, Lithium, Potassium and the like;
M¹ is the transition metal in the oxidation state +2;
M² is the transition metal in the oxidation state +3;
M³ is the transition metal in the oxidation state +4;
W is tungsten in oxidation state +3;
Wherein
0.67≤a≤1, preferably 0.85≤a≤1, further preferably 0.95≤a≤1,
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333;

In particular, the preferred cathode material have c+d+e+f=1

In yet another embodiment of the present invention, the tungsten doped mixed cation cathode active material is represented by formula (IA) comprising;

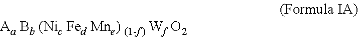

Wherein,
‘A’ comprises one or more alkali metals selected from Sodium, Lithium, or Potassium;
‘B’ comprises one or more alkali metals selected from Sodium, Lithium, or Potassium;
Ni is nickel in oxidation state +2;
Fe is iron in oxidation state +3;
Mn is manganese in oxidation state +4;
W is tungsten in oxidation state +3;
Wherein,
0.67≤a≤1, preferably 0.85≤a≤1, further preferably 0.95≤a≤1;
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333;
Wherein the cathode material preferably have c+d+e+f=1.

In still another embodiment of the present invention, the doped cathode active material of Formula (I) comprises:
i. Na_{0.95}K_{0.05}Ni_{0.33}Fe_{0.33}Mn_{0.33} W_{0.01}O₂,
ii. Na_{0.95}K_{0.05}Ni_{0.327}Fe_{0.327}Mn_{0.327} W_{0.02}O₂, and
iii. Na_{0.95}K_{0.05}Ni_{0.316}Fe_{0.316}Mn_{0.316} W_{0.05} O₂

In an embodiment of the present invention, the process for preparation of the cathode material of Formula (I) comprising co-precipitating a ternary/binary hydroxide of the base transition metal elements and further mixing with stoichiometric ratios of respective A, B, and W and calcination of the mixture to facilitate proper compound formation. Such a process may be conveniently performed in the presence of air, but it may also be performed under an inert atmosphere.

In another embodiment of the present invention, the process for the preparation of the cathode material of Formula (I) comprises the steps:
i. Preparing separate solutions of the base metal C, D & E in their respective stoichiometric ratios, and the second solution of a mixture of 1% or 2% or 5% Tungstic acid dissolved in both NaOH and NH4OH solutions, the second solution is further kept for vigorous stirring under an N2 atmosphere;
ii. Mixing the above two solutions simultaneously dropwise into a fixed volume stirred reactor followed by aging (mature) for a period of 12 hrs, under the stirring condition to allow homogenous particle formation, which is then washed, neutralized, and dried to form the ternary hydroxides;
iii. Intimately mixing the obtained ternary hydroxides of step (ii) with stoichiometric quantities of A and B salts;
iv. Heating the resulting mixture in a furnace under a suitable atmosphere and within a single temperature or over a range of temperatures between 450° C. and 900° C. until reaction product forms;
v. Allowing the product to cool before grinding it to a powder.

In still another embodiment of the present invention, the base metals C, D & E are Ni, Fe & Mn respectively.

The Table 1 below lists the starting materials and experimental conditions used to prepare a known (comparative) composition (Example 1) and the Target Active Materials of the present invention (Examples 2 to 4).

TABLE 1

| Sl. | | | |
|---|---|---|---|
| No | Electrode | Starting materials | Experimental conditions |
| 1. | NaNi_{0.33}Fe_{0.33}Mn_{0.33}W_{0.01}O₂ | 2M Ni Nitrate, Mn Nitrate, Fe | 850° C., Oxygen |
| | | Nitrate solution was drop wise | Dwell: 12 Hrs |
| | | added to 1% Tungstic acid | Ramp Rate: 10° C./min |
| | | Ammonia solution and | |
| | | Sodium hydroxide. | |
| | | (Ni_{0.33}Fe_{0.33}Mn_{0.33}W_{0.01})OH₂ | |
| | | powder and Sodium carbonate | |
| | | were mixed in an appropriate | |
| | | molar ratio in a rotatory mixer | |
| | | for approx. 1 hr | |
| 2. | Na_{0.95}K_{0.05}Ni_{0.33}Fe_{0.33}Mn_{0.33}W_{0.01}O₂ | 2M Ni Nitrate, Mn Nitrate, Fe | 850° C., Oxygen |
| | | Nitrate solution was drop wise | Dwell: 12 Hrs |
| | | added to 1% Tungstic acid | Ramp Rate: 10° C./min |
| | | Ammonia solution and | |
| | | Sodium hydroxide. | |
| | | (Ni_{0.33}Fe_{0.33}Mn_{0.33}W_{0.01})OH₂ | |
| | | powder and Sodium carbonate, | |
| | | Potassium carbonate were | |
| | | mixed in appropriate molar | |
| | | ratio in a rotatory mixer for | |
| | | approx. 1 hr | |
| 3. | Na_{0.95}K_{0.05}Ni_{0.327}Fe_{0.327}Mn_{0.327}W_{0.02}O₂ | 2M Ni Nitrate, Mn Nitrate, Fe | 850° C., Oxygen |
| | | Nitrate solution was drop wise | Dwell: 12 Hrs |
| | | added to 2% Tungstic acid | Ramp Rate: 10° C./min |
| | | Ammonia solution and | |
| | | Sodium hydroxide. | |
| | | (Ni_{0.33}Fe_{0.33}Mn_{0.33}W_{0.01})OH₂ | |
| | | powder and Sodium carbonate, | |
| | | Potassium carbonate were | |
| | | mixed in appropriate molar | |
| | | ratio in a rotatory mixer for | |
| | | approx. 1 hr | |
| 4. | Na_{0.95}K_{0.05}Ni_{0.316}Fe_{0.316}Mn_{0.316}W_{0.05}O₂ | 2M Ni Nitrate, Mn Nitrate, Fe | 850° C., Oxygen |
| | | Nitrate solution was drop wise | Dwell: 12 Hrs |
| | | added to 5% Tungstic acid | Ramp Rate: 10° C./min |
| | | Ammonia solution and | |
| | | Sodium hydroxide. | |
| | | (Ni_{0.33}Fe_{0.33}Mn_{0.33}W_{0.01})OH₂ | |
| | | powder and Sodium carbonate, | |
| | | Potassium carbonate were | |
| | | mixed in appropriate molar | |
| | | ratio in a rotatory mixer for | |
| | | approx. 1 hr | |

In still another embodiment of the present invention, the doped cathode active material of Formula (I) is stable, shows an improvement in specific capacity with little or no fading on cycling and, therefore, the energy density of devices made from present cathode is higher over undoped cathodes.

In an embodiment, the tungsten doped cathode active material exhibits the specific capacity in the range of 130-150 mAh/gm at 4V.

In an embodiment of the present invention, the present cathode active material has a novel anionic stoichiometry suitable for preparing energy storage devices, accordingly, the active material of Formula (I) find application in alkali ion-cell, in energy storage devices such as batteries, rechargeable batteries, electrochemical devices, and electrochemical devices.

In another embodiment of the present invention, the active material of Formula (I) is used as an electrode preferably a positive electrode (cathode), in conjunction with a counter electrode and one or more electrolyte materials in alkali ion-cell and in energy storage devices or electrochemical cell.

In still another embodiment of the present invention, the alkali-ion electrochemical cell comprising;
(i) the cathode consisting of tungsten doped mixed cation active material of the formula (I);

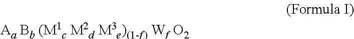

Wherein,
‘A’ comprises one or more alkali metal selected from Sodium, Lithium, Potassium and the like;
‘B’ comprises one or more alkali metal selected from Sodium, Lithium, Potassium and the like;
M¹ is the transition metal in the oxidation state +2;
M² is the transition metal in the oxidation state +3;
M³ is the transition metal in the oxidation state +4;
W is tungsten in oxidation state +3;
Wherein
0.67≤a≤1, preferably 0.85≤a≤1, further preferably 0.95≤a≤1,
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333.
(ii) an anode selected from graphite, hard carbon, and silicon;
(iii) a separator; and
(iv) a non-aqueous electrolyte comprising 0.8M NaPF6-PC:EMC:FEC:PST:DDT composition.

In particular, the preferred cathode material have c+d+e+f=1

In yet another embodiment of the present invention, the cathode active material of Formula (I) in the alkali-ion electrochemical cell is arranged in series, parallel, or both.

In another embodiment of the present invention, during the cell charging process, host ions comprising the larger alkali metal ions migrate from the electrolyte and cathode and are inserted into the sodium anode, increasing the gallery height of the said carbon anode layers, thereby helping in unimpeded movement of the smaller host ions, leading to better capacity retention across multiple cycles in the cell comprising the said cathode, a standard anode, and an electrolyte. As the nickel ions are deintercalated from the cathode, they undergo oxidation from +2 to +4 oxidation states with a small contribution from Fe3+ to Fe4+ oxidation states. The capacity contribution of Manganese is insignificant and is only seen below 3V as a sloping curve. A subsequent discharge process extracts the host ions from sodium and reintroduces them into the cathode. In other words, during the charging process, the potential difference created makes the larger cation move towards the anode and intercalate into the structure and the reverse happens during discharging. The nature of the electrode intercalation material influences the resulting voltage of the battery since the voltage is the difference between the half-cell potentials at the cathode and anode.

In still another embodiment of the present invention, the charge-discharge profile of the present electrode active material of Formula (I) exhibits smooth discharging curve from 4V to 2V when used as the cathode in energy storage devices comprising sodium metal as the anode and 0.8M NaPF6-PC:EMC:FEC:PST:DDT as the electrolyte.

### EXAMPLES

The following examples, which include preferred embodiments, will serve to illustrate the practice of this invention, it being understood that the particulars shown are by way of example and for purpose of illustrative discussion of preferred embodiments of the invention.

### Comparative Example 1:—Composites of NaNi_{0.333} Fe_{0.333} Mn_{0.333}O₂

The composition NaNi_{0.333}Fe_{0.333}Mn_{0.333}O₂ is used as a cathode active material in the half cell format using sodium metal as anode. Further, 0.8M NaPF6-PC:EMC:FEC:PST:DDT is used as an electrolyte. The ratio of the carbonate is fixed to 4:6 and 2, 1, and 1 vol % of other additives were added. The cell was charged to 4V at 25 degrees at a 0.5 C rate.

FIG. 1 depict the schematic representation of cell voltage profile for the first 5 charge/discharge cycles of the half-cell having sodium metal as anode material and NaNi_{0.333}Fe_{0.333}Mn_{0.333}O₂ as cathode active material which is charged up to 4V at 25 degrees using 0.8M NaPF6-PC:EMC:2% FEC:1% PST:1% DTD as electrolyte.

The half-cell having sodium metal as anode material and NaNi_{0.333}Fe_{0.333}Mn_{0.333}O₂ as cathode active material have a capacity of 110 mAh/g.

### Example 1:—Composites of Na Ni_{0.33} Fe_{0.33} Mn_{0.33} W_{0.01}O₂

The composition Na Ni_{0.33} Fe_{0.33} Mn_{0.33} W_{0.01}O₂ is used as a cathode active material in the half cell format using sodium metal as anode. Further, 0.8M NaPF6-PC:EMC:FEC:PST:DDT is used as an electrolyte. The ratio of the carbonate is fixed to 4:6 and 2, 1, and 1 vol % of other additives were added. The cell was charged to 4V at 25 degrees at a 0.5 C rate.

FIG. 2 depict the schematic representation of cell voltage profile for the first 5 charge/discharge cycles of the half-cell having sodium metal as anode material and Na Ni_{0.33} Fe_{0.33} Mn_{0.33} W_{0.01}O₂ as cathode active material which is charged up to 4V at 25 degrees using 0.8M NaPF6-PC:EMC:2% FEC:1% PST:1% DTD as electrolyte.

The W doped material achieved a high capacity of 130 mAh/g which is higher than comparative example of undoped material.

### Example 2. Composites of Na_{0.95}K_{0.05} Ni_{0.33}Fe_{0.33}Mn_{0.33} W_{0.01}O₂

The composition Na_{0.95}K_{0.05} Ni_{0.33}Fe_{0.33}Mn_{0.33} W_{0.01}O₂ is used as a cathode active material in the half cell format using sodium metal as anode. Further, 0.8M NaPF6-PC:EMC:FEC:PST:DDT is used as an electrolyte. The ratio of the carbonate is fixed to 4:6 and 2, 1, and 1 vol % of other additives were added. The cell was charged to 4V at 25 degrees at a 0.5 C rate.

FIG. 3 depict the schematic representation of cell voltage profile for the first 5 charge/discharge cycles of a half-cell having sodium metal as anode material and Na_{0.95}K_{0.05} Ni_{0.33}Fe_{0.33} Mn_{0.33} W_{0.01}O₂ as cathode active material which is charged up to 4V at 25 degrees using 0.8M NaPF6-PC:EMC:2% FEC:1% PST:1% DTD as electrolyte.

The composition with combination of K+ and W doping delivered higher capacity of 135 mAh/g compared to one Example 1 and comparative example both.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

We claim:

1. A tungsten doped mixed cation cathode active material of formula (I) comprising; 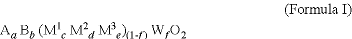
wherein,
‘A’ comprises one or more alkali metal selected from Sodium, Lithium, Potassium and the like;
‘B’ comprises one or more alkali metal selected from Sodium, Lithium, Potassium and the like;
M1 is the transition metal in the oxidation state +2;
M2 is the transition metal in the oxidation state +3;
M3 is the transition metal in the oxidation state +4;
W is tungsten in oxidation state +3;
wherein,
0.67≤a≤1, preferably 0.85≤a≤1, further preferably 0.95≤a≤1;
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333.

2. The tungsten doped cathode active material as claimed in claim 1, of formula (1A) comprising: 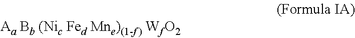
wherein,
‘A’ comprises one or more alkali metals selected from Sodium, Lithium, or Potassium;
‘B’ comprises one or more alkali metals selected from Sodium, Lithium, or Potassium;
Ni is nickel in oxidation state +2;
Fe is iron in oxidation state +3;
Mn is manganese in oxidation state +4;
W is tungsten in oxidation state +3;
wherein,
0.67≤a≤1, preferably 0.85≤a≤1, further preferably 0.95≤a≤1;
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333.

3. The tungsten doped cathode active material as claimed in claim 2, wherein c+d+e+f=1.

4. The tungsten doped mixed cation cathode active material of Formula (I) as claimed in any of the claims 1 to 3, comprises:
i. Na_{0.95}K_{0.05}Ni_{0.33}Fe_{0.33}Mn_{0.33} W_{0.01}O₂,
ii. Na_{0.95}K_{0.05}Ni_{0.327}Fe_{0.327}Mn_{0.327} W_{0.02}O₂, and
iii. Na_{0.95}K_{0.05}Ni_{0.316}Fe_{0.316}Mn_{0.316} W_{0.05} O₂

5. A process for preparation of the cathode active material of Formula (I) comprising;
i. Preparing separate solutions of the base metal C, D & E in their respective stoichiometric ratios, and the second solution of a mixture of 1% or 2% or 5% Tungstic acid dissolved in both NaOH and NH4OH solutions, wherein the second solution is further kept for vigorous stirring under an N2 atmosphere;
ii. Mixing the above two solutions simultaneously drop wise into a fixed volume stirred reactor followed by aging (maturing) for a period of 12 hrs, under the stirring condition to allow homogenous particle formation, which is then washed, neutralized, and dried to form the ternary hydroxides;
iii. Intimately mixing the obtained ternary hydroxides of step (ii) with stoichiometric quantities of A and B salts;
iv. Heating the resulting mixture in a furnace under a suitable atmosphere over a temperature range of 450° C. to 900° C. until reaction product forms; and
v. Allowing the product to cool before grinding it to a powder.

6. The process for preparation as claimed in claim 4, wherein, the base metals C, D & E are Ni, Fe & Mn respectively.

7. Use of the tungsten doped mixed cation active material as claimed in claim 1, in alkali ion-cell, in energy storage devices such as batteries, rechargeable batteries, electrochemical devices, and electrochemical devices.

8. A alkali-ion electrochemical cell comprising;
i. the cathode consisting of tungsten doped mixed cation active material of the formula (I); 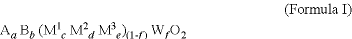
wherein,
‘A’ comprises one or more alkali metal selected from Sodium, Lithium, Potassium and the like;
‘B’ comprises one or more alkali metal selected from Sodium, Lithium, Potassium and the like;
M1 is the transition metal in the oxidation state +2;
M2 is the transition metal in the oxidation state +3;
M3 is the transition metal in the oxidation state +4;
W is tungsten in oxidation state +3;
Wherein
0.67≤a≤1, preferably 0.85≤a≤1, further preferably 0.95≤a≤1,
0.01≤b≤0.25, preferably 0.01≤b≤0.1, further preferably 0.01≤b≤0.05;
0≤c≤0.5, preferably 0≤c≤0.45, further preferably 0≤c≤0.333;
0≤d≤0.5, preferably 0≤d≤0.45, further preferably 0≤d≤0.333;
0≤e≤0.5, preferably 0≤e≤0.45, further preferably 0≤e≤0.333;
ii. an anode selected from graphite, hard carbon, and silicon;
iii. a separator; and
iv. a non-aqueous electrolyte comprising 0.8M NaPF6-PC:EMC:FEC:PST:DDT composition.

9. The tungsten doped cathode material as claimed in any one of the preceding claims wherein said cathode material is stable, shows specific capacity of 130-150 mAh/gm with little or no fading on cycling and has higher energy density

10. A method of charging and discharging the electrochemical cell with the tungsten doped mixed cation cathode active material as claimed in claim 1.
